(19) United States
(12) Patent Application Publication
(10) Pub. No.: US 2014/0356035 A1
(43) Pub. Date: Dec. 4, 2014

(54) IMAGE FORMING APPARATUS

(71) Applicant: FUJI XEROX CO., LTD., Tokyo (JP)

(72) Inventors: Yasumitsu HARASHIMA, Kanagawa (JP); Toko HARA, Kanagawa (JP); Yutaka KIUCHI, Kanagawa (JP); Miho IKEDA, Kanagawa (JP); Takaharu NAKAJIMA, Kanagawa (JP); Koichiro YUASA, Kanagawa (JP)

(73) Assignee: FUJI XEROX CO., LTD., Tokyo (JP)

(21) Appl. No.: 14/098,107

(22) Filed: Dec. 5, 2013

(30) Foreign Application Priority Data
Jun. 4, 2013 (JP) 2013-118211

(51) Int. Cl. G03G 15/20

(52) U.S. Cl. CPC G03G 15/2064; G03G 15/0105
USPC 399/321

(57) ABSTRACT

An image forming apparatus includes: a first image forming section that forms a first image using a first toner containing flat pigment particles; a second image forming section that forms a second image using a second toner not containing the flat pigment particles; and a fixing section that fixes the first image to a recording medium with a quantity of heat that is smaller than that for a case where the fixing section fixes a third image not including the first image but including the second image.

### CROSS-REFERENCE TO RELATED APPLICATIONS

This application is based on and claims priority under 35 USC 119 from Japanese Patent Application No. 2013-118211 filed Jun. 4, 2013.

### BACKGROUND

### Technical Field

The present invention relates to an image forming apparatus.

### SUMMARY

According to an aspect of the present invention, there is provided an image forming apparatus including: a first image forming section that forms a first image using a first toner containing flat pigment particles; a second image forming section that forms a second image using a second toner not containing the flat pigment particles; and a fixing section that fixes the first image to a recording medium with a quantity of heat that is smaller than that for a case where the fixing section fixes a third image not including the first image but including the second image.

### BRIEF DESCRIPTION OF THE DRAWINGS

Exemplary embodiments of the present invention will be described in detail based on the following figures, wherein:

FIGS. 1A and 1B are each a cross-sectional view illustrating the posture of flat pigment particles contained in a toner image formed by an image forming apparatus according to a first exemplary embodiment of the present invention, illustrated together with that according to a comparative example;

FIGS. 2A and 2B are each a plan view illustrating the posture of the flat pigment particles contained in the toner image formed by the image forming apparatus according to the first exemplary embodiment of the present invention, illustrated together with that according to a comparative example;

FIGS. 3A and 3B are a plan view and a side view, respectively, of a flat pigment particle contained in a toner used by the image forming apparatus according to the first exemplary embodiment of the present invention;

FIG. 4 is a graph illustrating the relationship between the brilliance and the quantity of heat during fixation of the toner image formed by the image forming apparatus according to the first exemplary embodiment of the present invention;

FIG. 5 illustrates the configuration of a toner image forming section provided in the image forming apparatus according to the first exemplary embodiment of the present invention;

FIG. 6 illustrates the configuration of an image forming section provided in the image forming apparatus according to the first exemplary embodiment of the present invention; and

FIG. 7 illustrates a schematic configuration of the image forming apparatus according to the first exemplary embodiment of the present invention.

### DETAILED DESCRIPTION

Exemplary embodiments of the present invention will be described below with reference to the drawings. In the drawings, the arrow H indicates the vertical direction, and the arrow W indicates the horizontal direction corresponding to the apparatus width direction.

### First Exemplary Embodiment

<Overall Configuration of Image Forming Apparatus>

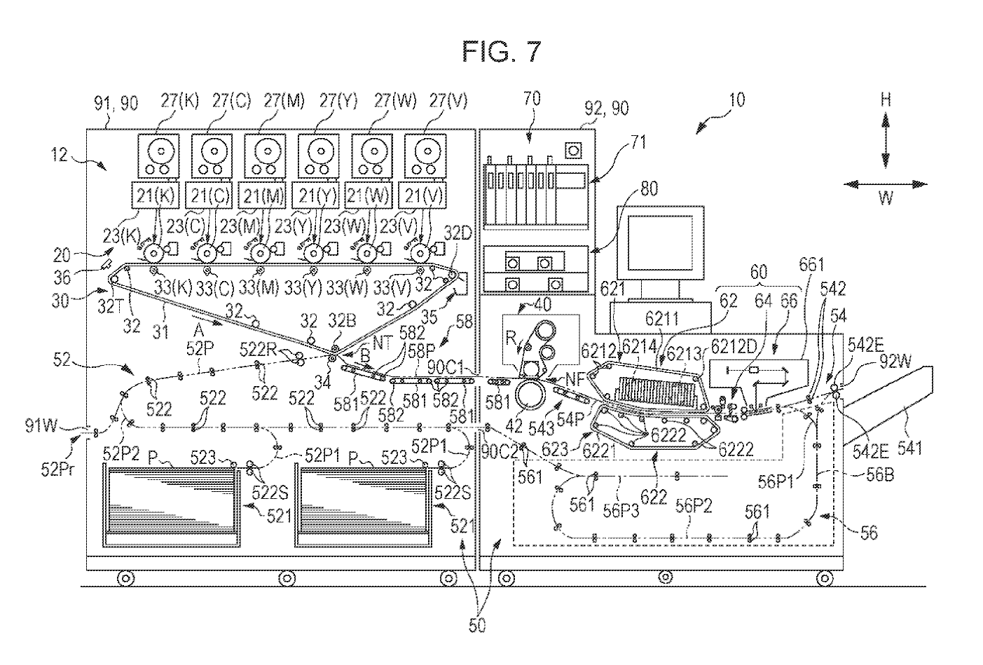

FIG. 7 is a schematic diagram illustrating an overall configuration of an image forming apparatus 10 as seen from the front side. As illustrated in the drawing, the image forming apparatus 10 includes an image forming section 12 that forms an image on a sheet member P that serves as a recording medium through an electrophotographic system, a medium transport device 50 that transports the sheet member P, and a post-processing section 60 that performs post-processing etc. on the sheet member P on which an image has been formed.

The image forming apparatus 10 also includes a controller 70 that controls the various sections discussed earlier and a power source section 80 to be discussed later, and the power source section 80 which supplies power to the various sections described above including the controller 70.

The image forming section 12 includes a toner image forming section 20 that forms a toner image, a transfer device 30 that transfers the toner image formed by the toner image forming section 20 to the sheet member P, and a fixing device 40 (an example of a fixing section) that fixes the toner image transferred to the sheet member P to the sheet member P.

The medium transport device 50 includes a medium supply section 52 that supplies the sheet member P to the image forming section 12, and a medium ejection section 54 that ejects the sheet member P on which the toner image has been formed. The medium transport device 50 also includes a medium return section 56 used to form an image on both surfaces of the sheet member P, and an intermediate transport section 58 to be discussed later.

The post-processing section 60 includes a medium cooling section 62 that cools the sheet member P to which the toner image has been transferred in the image forming section 12, a correction device 64 that corrects curl of the sheet member P, and an image inspection section 66 that inspects the image formed on the sheet member P. The various sections forming the post-processing section 60 are disposed in the medium ejection section 54 of the medium transport device 50.

The various sections of the image forming apparatus 10 are housed in a housing 90 except for an ejected medium receiving section 541 forming the medium ejection section 54 of the medium transport device 50. In the exemplary embodiment, the housing 90 is dividable into a first housing 91 and a second housing 92 that are adjacent to each other in the apparatus width direction. This reduces the transport size of the image forming apparatus 10 in the apparatus width direction.

The first housing 91 houses a principal portion of the image forming section 12 excluding the fixing device 40 to be discussed later, and the medium supply section 52. The second housing 92 houses the fixing device 40 forming the image forming section 12, the medium ejection section 54 excluding the ejected medium receiving section 541, the medium cooling section 62, the image inspection section 66, the medium return section 56, the controller 70, and the power source section 80. The first housing 91 and the second housing 92 are coupled to each other by a fastening unit such as a bolt and a nut (not illustrated), for example. With the first housing 91 and the second housing 92 coupled to each other, a communication opening portion 90C1 for the sheet member P that extends from a transfer nip NT to a fixing nip NF of the image forming section 12 to be discussed later and a communication passage 90C2 for the sheet member P that extends from the medium return section 56 to the medium supply section 52 are formed between the first housing 91 and the second housing 92.

(Image Forming Section)

As discussed earlier, the image forming section 12 includes the toner image forming section 20, the transfer device 30, and the fixing device 40. Plural toner image forming sections 20 are provided to form toner images in respective colors. In the exemplary embodiment, toner image forming sections 20 for six colors, namely a first special color (V), a second special color (W), yellow (Y), magenta (M), cyan (C), and black (K), are provided. The symbols (V), (W), (Y), (M), (C), and (K) used in FIG. 7 indicate the respective colors described above. The transfer device 30 transfers toner images in the six colors from a transfer belt 31, to which the toner images in the six colors superimposed on each other have been transferred through a first transfer, to the sheet member P at the transfer nip NT.

In the exemplary embodiment, for example, the first special color (V) is a silver color for which a toner containing flat pigment particles is used as discussed later. Meanwhile, the second special color (W) is a corporate color specific to a user that is used frequently compared to the other colors.

[Toner Image Forming Section]

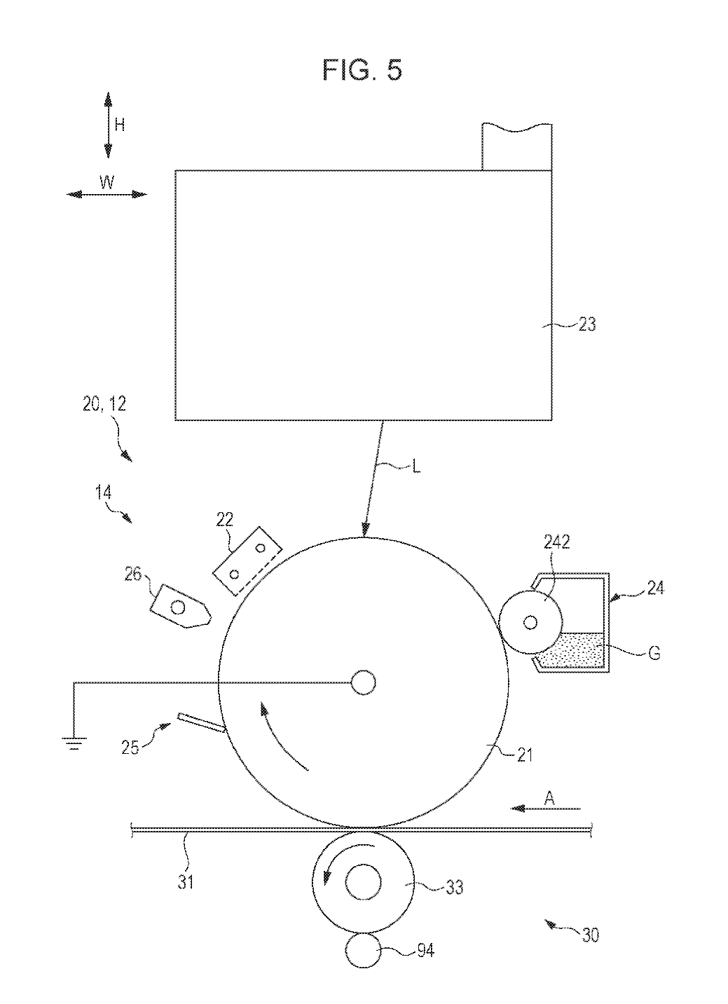

The toner image forming sections 20 for the respective colors are basically formed in the same manner except for the toners to be used. Thus, toner image forming sections 20 for the respective colors will be described below without being specifically differentiated from each other. As illustrated in FIG. 5, the toner image forming section 20 includes a photosensitive drum 21 that serves as an example of an image holding element, a charging unit 22, an exposure device 23, a developing device 24 that serves as an example of a developing unit, a cleaning device 25, and a static eliminating device 26.

[Photosensitive Drum]

The photosensitive drum 21 is formed in a cylindrical shape, grounded, and driven by a drive unit (not illustrated) so as to rotate about its own axis. A photosensitive layer that provides a negative charging polarity, for example, is formed on the surface of the photosensitive drum 21. As illustrated in FIG. 7, the photosensitive drums 21 for the respective colors are disposed in line with each other along the apparatus width direction as seen from the front.

[Charging Unit]

As illustrated in FIG. 5, the charging unit 22 charges the surface (photosensitive layer) of the photosensitive drum 21 to a negative polarity. In the exemplary embodiment, the charging unit 22 is a scorotron charging unit of a corona discharge type (non-contact charging type).

[Exposure Device]

The exposure device 23 forms an electrostatic latent image on the surface of the photosensitive drum 21. Specifically, the exposure device 23 radiates modulated exposure light L to the surface of the photosensitive drum 21, which has been charged by the charging unit 22, in accordance with image data received from an image signal processing section 71 (see FIG. 7) that forms the controller 70. An electrostatic latent image is formed on the surface of the photosensitive drum 21 by the exposure light L radiated by the exposure device 23.

[Developing Device]

The developing device 24 develops the electrostatic latent image formed on the surface of the photosensitive drum 21 using a developer G containing a toner to form a toner image on the surface of the photosensitive drum 21. A toner cartridge 27 that supplies the developer G is connected to the developing device 24 via a supply path (not illustrated). Toner cartridges 27 for the respective colors are disposed above the photosensitive drums 21 and the exposure devices 23 in line with each other in the apparatus width direction as seen from the front so as to be individually replaceable.

[Cleaning Device]

The cleaning device 25 is formed as a blade that scrapes off a toner that remains on the surface of the photosensitive drum 21 after the toner image is transferred to the transfer device 30 from the surface of the photosensitive drum 21.

[Static Eliminating Device]

The static eliminating device 26 eliminates static by radiating light to the photosensitive drum 21 after the transfer. This causes the charging history of the surface of the photosensitive drum 21 to be canceled.

[Transfer Device]

The transfer device 30 performs a first transfer of the toner images on the photosensitive drums 21 for the respective colors onto the transfer belt 31 as superimposed on each other, and performs a second transfer of the superimposed toner images onto the sheet member P. The transfer device 30 will be specifically described below.

[Transfer Belt]

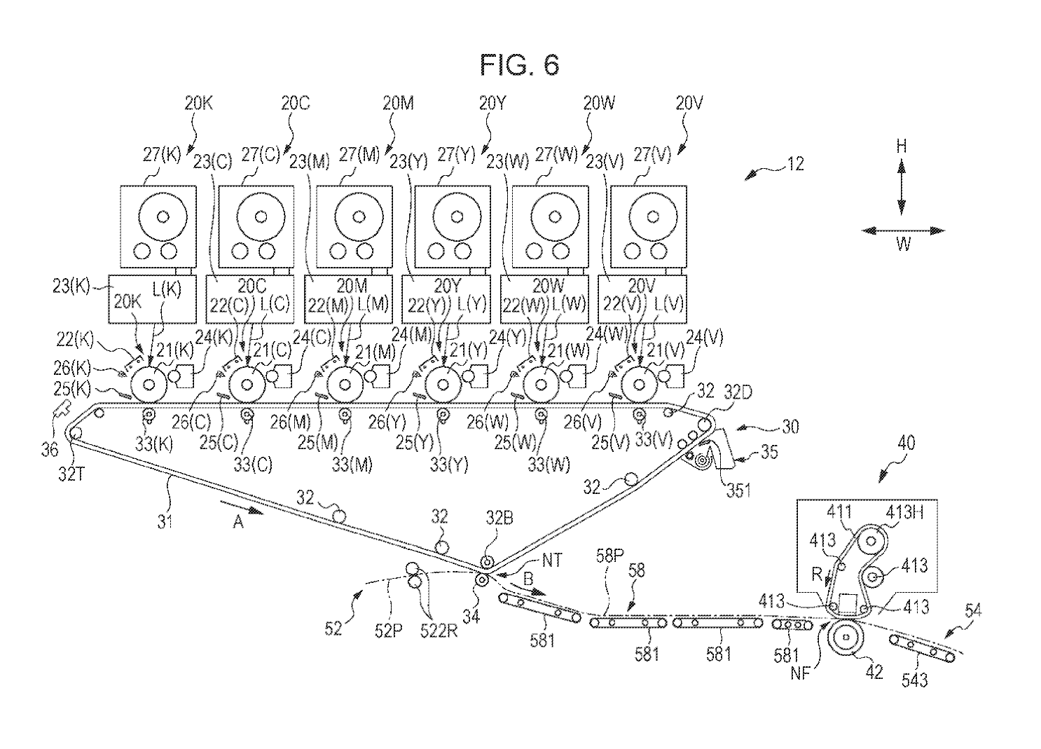

As illustrated in FIG. 6, the transfer belt 31 has an endless shape, and is wound around plural rollers 32 to determine its posture. In the exemplary embodiment, the transfer belt 31 has a posture of an inverted obtuse triangle that is long in the apparatus width direction as seen from the front. Of the plural rollers 32, a roller 32D illustrated in FIG. 6 functions as a drive roller that applies power of a motor (not illustrated) to circulate the transfer belt 31 in the direction of the arrow A.

Of the plural rollers 32, a roller 32T illustrated in FIG. 6 functions as a tension applying roller that applies a tension to the transfer belt 31. Of the plural rollers 32, a roller 32B illustrated in FIG. 6 functions as a counter roller for a second transfer roller 34 to be discussed later. The lower-end vertex of the transfer belt 31, which forms the obtuse angle of the fixing belt 31 in the posture of an inverted obtuse triangle as discussed earlier, is wound around the roller 32B. The upper side of the transfer belt 31 which extends in the apparatus width direction with the transfer belt 31 in the posture discussed earlier contacts the photosensitive drums 21 for the respective colors from below.

[First Transfer Roller]

First transfer rollers 33 that serve as examples of a transfer member that transfers the toner image on each photosensitive drum 21 to the transfer belt 31 are disposed inside the transfer belt 31. The first transfer rollers 33 are disposed opposite to the photosensitive drums 21 for the corresponding colors across the transfer belt 31. The first transfer rollers 33 are applied with a transfer bias voltage that is opposite in polarity to the toner polarity. Application of the transfer bias voltage causes the toner images formed on the photosensitive drums 21 to be transferred to the transfer belt 31.

[Second Transfer Roller]

The transfer device 30 also includes the second transfer roller 34 which transfers the superimposed toner images on the transfer belt 31 to the sheet member P. The second transfer roller 34 is disposed with the transfer belt 31 interposed between the roller 32B and the second transfer roller 34 to form the transfer nip NT between the transfer belt 31 and the second transfer roller 34. The sheet member P is supplied to the transfer nip NT from the medium supply section 52 at an appropriate timing. The second transfer roller 34 is applied with a transfer bias voltage that is opposite in polarity to the toner polarity by a power supply section (not illustrated). Application of the transfer bias voltage causes the toner images to be transferred from the transfer belt 31 to the sheet member P which passes through the transfer nip NT.

[Cleaning Device]

The transfer device 30 further includes the cleaning device 35 which cleans the transfer belt 31 after the second transfer. The cleaning device 35 is disposed downstream of the location at which the second transfer is performed (the transfer nip NT) and upstream of the location at which the first transfer is performed in the direction of circulation of the transfer belt 31. The cleaning device 35 includes a blade 351 that scrapes off a toner that remains on the surface of the transfer belt 31 from the surface of the transfer belt 31.

[Fixing Device]

The fixing device 40 fixes the toner images transferred to the sheet member P in the transfer device 30 to the sheet member P. In the exemplary embodiment, the fixing device 40 is configured to fix the toner images to the sheet member P by heating and pressurizing the toner images at the fixing nip NF formed by a fixing belt 411 wound around plural rollers 413 and a pressurizing roller 42. A roller 413H serves as a heating roller that includes a built-in heater, for example, and that is rotated by a drive force transmitted from a motor (not illustrated). This causes the fixing belt 411 to be circulated in the direction of the arrow R.

The pressurizing roller 42 is rotated by a drive force transmitted from a motor (not illustrated) at a peripheral velocity that is generally the same as the peripheral velocity of the fixing belt 411.

(Medium Transport Device)

As illustrated in FIG. 7, the medium transport device 50 includes the medium supply section 52, the medium ejection section 54, the medium return section 56, and the intermediate transport section 58.

[Medium Supply Section]

The medium supply section 52 includes a container 521 that stores the sheet members P stacked on each other. In the exemplary embodiment, two containers 521 are disposed side by side along the apparatus width direction below the transfer device 30.

A medium supply passage 52P is formed by plural transport roller pairs 522, guides (not illustrated), and so forth to extend from each container 521 to the transfer nip NT as the second transfer position. The medium supply passage 52P is turned back in the apparatus width direction at two turning portions 52P1 and 52P2 while being raised to form a shape that leads to the transfer nip NT (a generally “S” shape).

A feed roller 523 that feeds the uppermost one of the sheet members P stored in the container 521 is disposed on the upper side of each container 521. Of the plural transport roller pairs 522, a transport roller pair 522S on the most upstream side in the transport direction of the sheet member P functions as separation rollers that separate the sheet members P fed from the container 521 by the feed roller 523 in a superposed state from each other. Of the plural transport roller pairs 522, a transport roller pair 522R positioned immediately upstream of the transfer nip NT in the transport direction of the sheet member P operates such that the timing of movement of the toner images on the transfer belt 31 and the timing of transport of the sheet member P match each other.

The medium supply section 52 includes a preliminary transport passage 52Pr. The preliminary transport passage 52Pr starts at an opening portion 91W of the first housing 91 provided opposite to the second housing 92 to be merged with the turning portion 52P2 of the medium supply passage 52P. The preliminary transport passage 52Pr serves as a transport passage that feeds the sheet member P fed from an optional recording medium supply device (not illustrated) disposed adjacent to the opening portion 91W of the first housing 91 to the image forming section 12.

[Intermediate Transport Section]

As illustrated in FIG. 6, the intermediate transport section 58 is disposed to extend from the transfer nip NT of the transfer device 30 to the fixing nip NF of the fixing device 40, and includes plural belt transport members 581 that each include an endless transport belt wound around rollers.

The intermediate transport section 58 transports the sheet member P by circulating the transport belt with the belt transport members 581 suctioning air (to generate a negative pressure) to draw the sheet member P to the surface of the transport belt.

[Medium Ejection Section]

As illustrated in FIG. 7, the medium ejection section 54 ejects the sheet member P to which the toner images have been fixed by the fixing device 40 of the image forming section 12 to the outside of the housing 90 from an ejection port 92W formed at an end portion of the second housing 92 opposite to the first housing 91.

The medium ejection section 54 includes an ejected medium receiving section 541 that receives the sheet member P ejected from the ejection port 92W.

The medium ejection section 54 has a medium ejection passage 54P through which the sheet member P is transported from the fixing device 40 (the fixing nip NF) to the ejection port 92W. The medium ejection passage 54P is formed from a belt transport member 543, plural roller pairs 542, guides (not illustrated), and so forth. Of the plural roller pairs 542, a roller pair 542E disposed on the most downstream side in the ejection direction of the sheet member P functions as ejection rollers that eject the sheet member P onto the ejected medium receiving section 541.

[Medium Return Section]

The medium return section 56 includes plural roller pairs 561. The plural roller pairs 561 form a reverse passage 56P to which the sheet member P having passed through the image inspection section 66 is fed in the case where there is a request to form an image on both surfaces of the sheet member P. The reversal passage 56P has a branch path 56P1, a transport path 56P2, and a reverse path 56P3. The branch path 56P1 is branched from the medium ejection passage 54P. The transport path 56P2 feeds the sheet member P received from the branch path 56P1 to the medium supply passage 52P. The reverse path 56P3 is provided in the middle of the transport path 56P2, and reverses the front and back sides of the sheet member P by changing the transport direction of the sheet member P transported through the transport path 56P2 into the opposite direction (through switchback transport).

(Post-processing Section)

The medium cooling section 62, the correction device 64, and the image inspection section 66 which form the post-processing section 60 are disposed on a portion of the medium ejection passage 54P of the medium ejection section 54 provided upstream of the branch portion of the branch path 56P1 in the ejection direction of the sheet member P, and arranged sequentially in the order in which they are mentioned from the upstream side in the ejection direction.

[Medium Cooling Section]

The medium cooling section 62 includes a heat absorbing device 621 that absorbs heat of the sheet member P, and a pressing device 622 that presses the sheet member P against the heat absorbing device 621. The heat absorbing device 621 is disposed on the upper side of the medium ejection passage 54P. The pressing device 622 is disposed on the lower side of the medium ejection passage 54P.

The heat absorbing device 621 includes an endless heat absorbing belt 6211, plural rollers 6212 that support the heat absorbing belt 6211, a heat sink 6213 disposed on the inner side of the heat absorbing belt 6211, and a fan 6214 that cools the heat sink 6213.

The outer peripheral surface of the heat absorbing belt 6211 contacts the sheet member P so as to be able to exchange heat with the sheet member P. Of the plural rollers 6212, a roller 6212D functions as a drive roller that transmits a drive force to the heat absorbing belt 6211. The heat sink 6213 makes slidable surface contact with the inner peripheral surface of the heat absorbing belt 6211 over a predetermined range along the medium ejection passage 54P.

The pressing device 622 includes an endless pressing belt 6221, and plural rollers 6222 that support the pressing belt 6221. The pressing belt 6221 is wound around the plural rollers 6222. The pressing device 622 transports the sheet member P together with the heat absorbing belt 6211 while pressing the sheet member P against the heat absorbing belt 6211 (the heat sink 6213).

[Correction Device]

The correction device 64 is provided downstream of the medium cooling section 62 in the medium ejection section 54. The correction device 64 corrects curl of the sheet member P received from the medium cooling section 62.

[Image Inspection Section]

An in-line sensor 661 that forms a principal portion of the image inspection section 66 is disposed downstream of the correction device 64 in the medium ejection section 54. The in-line sensor 661 detects the presence or absence of, and the degree of, a defect in toner concentration, an image defect, a defect in image position, and so forth of the fixed toner image on the basis of light radiated to the sheet member P and reflected from the sheet member P.

<Image Forming Operation (Effect) of Image Forming Apparatus>

Next, an overview of an image forming process and a post-processing process performed on the sheet member P by the image forming apparatus 10 will be described.

As illustrated in FIG. 7, when an image forming instruction is received, the controller 70 actuates the toner image forming section 20, the transfer device 30, and the fixing device 40. This rotates the photosensitive drum 21 of the toner image forming section 20 and a developing roller 242 of the developing device 24 for each color to circulate the transfer belt 31 as illustrated in FIG. 6. This also rotates the pressurizing roller 42 to circulate the fixing belt 411. In synchronization with these operations, the controller 70 further actuates the medium transport device 50 and so forth.

This causes the photosensitive drum 21 for each color to be charged by the charging unit 22 while being rotated. The controller 70 sends image data which have been subjected to image processing performed by the image signal processing section to each exposure device 23. The exposure device 23 outputs exposure light L in accordance with the image data to expose the charged photosensitive drum 21 to the light. Then, an electrostatic latent image is formed on the surface of the photosensitive drum 21. The electrostatic latent image formed on the photosensitive drum 21 is developed using a developer supplied from the developing device 24. Consequently, a toner image in the corresponding color among the first special color (V), the second special color (W), yellow (Y), magenta (M), cyan (C), and black (K) is formed on the photosensitive drum 21 for each color.

The toner images in the respective colors formed on the photosensitive drums 21 for the respective colors are sequentially transferred to the circulating transfer belt 31 by applying a transfer bias voltage through the first transfer rollers 33 for the respective colors. This causes a superimposed toner image obtained by superimposing the toner images in the respective colors to be formed on the transfer belt 31. The superimposed toner image is transported to the transfer nip NT by the circulation of the transfer belt 31.

As illustrated in FIG. 7, the sheet member P is supplied to the transfer nip NT by the transport roller pair 522R of the medium supply section 52 at a timing that matches the transport of the superimposed toner image. Application of the transfer bias voltage at the transfer nip NT causes the superimposed toner image to be transferred from the transfer belt 31 to the sheet member P.

The sheet member P to which the toner image has been transferred is transported by the intermediate transport section 58 from the transfer nip NT of the transfer device 30 to the fixing nip NF of the fixing device 40. The fixing device 40 applies heat and a pressure to the sheet member P passing through the fixing nip NF. This causes the transferred toner image to be fixed to the sheet member P.

The sheet member P ejected from the fixing device 40 is processed by the post-processing section 60 while being transported by the medium ejection section 54 to the ejected medium receiving section 541 outside the apparatus. The sheet member P heated in the fixing process is first cooled in the medium cooling section 62. Then, the sheet member P is corrected for its curl by the correction device 64. The image inspection section 66 detects the presence or absence of, and the degree of, a defect in toner concentration, an image defect, a defect in image position, and so forth of the toner image fixed to the sheet member P. The sheet member P is ejected to the medium ejection section 54.

Meanwhile, in the case where an image is to be formed on a non-image surface of the sheet member P on which no image is formed (in the case of double-sided printing), the controller 70 switches the transport passage for the sheet member P after passing through the image inspection section 66 from the medium ejection passage 54P of the medium ejection section 54 to the branch path 56P1 of the medium return section 56. This causes the sheet member P to be fed to the medium supply passage 52P with its front and back sides reversed by way of the reverse passage 56P. An image is formed (fixed) on the back surface of the sheet member P in the same process as the image forming process performed on the front surface discussed earlier. The sheet member P is ejected by the medium ejection section 54 to the ejected medium receiving section 541 outside the apparatus through the same process as the process performed after an image is formed on the front surface discussed earlier.

<Configuration of Principal Portion>

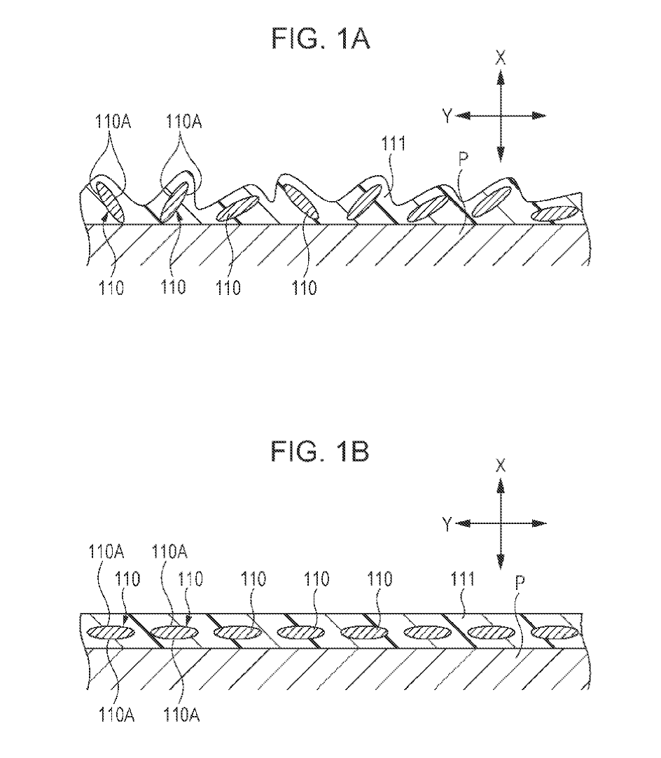

In the exemplary embodiment, a toner image forming section 20V (an example of a first image forming section; see FIG. 6) is configurated to form a toner image using a toner (silver toner) in the silver color as the first special color (V). As illustrated in FIG. 1A, the silver toner used by the toner image forming section 20V contains pigment particles 110 that serve as examples of flat pigment particles, and a binder resin 111.

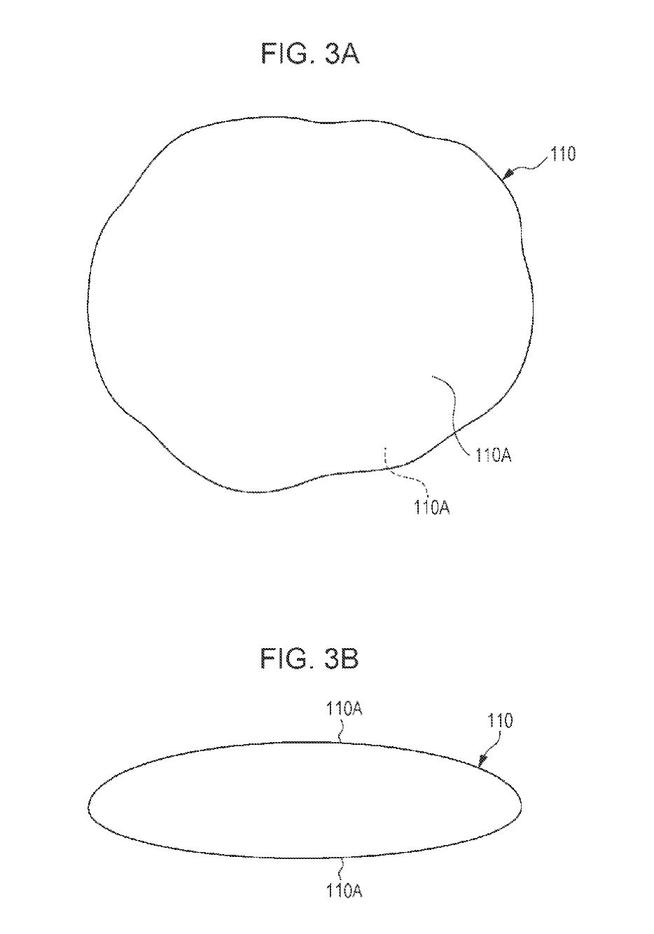

The pigment particles 110 are made of aluminum. As illustrated in FIG. 3B, the pigment particles 110 are shaped such that, when placed on a flat surface and seen from a side, their dimension in the horizontal direction (Y direction) in the drawing is larger than their dimension in the vertical direction (X direction) in the drawing. The dimensional ratio between the dimension in the horizontal direction and the dimension in the vertical direction of the pigment particles 110 is set to be larger than the relevant dimensional ratio of pigment particles in toners in the other colors to be discussed later.

When the pigment particle 110 illustrated in FIG. 3B is seen from the upper side in the drawing, the pigment particle 110 has a more spread shape as illustrated in FIG. 3A than its shape as seen from a side. The pigment particle 110 has a pair of reflective surfaces 110A that face upward and downward with the pigment particle 110 placed on a flat surface (see FIG. 3B). Consequently, the pigment particles 110 have a flat shape.

On the other hand, toners in colors such as the second special color (W), yellow (Y), magenta (M), cyan (C), and black (K) that are used by the toner image forming sections 20W, 20Y, 20M, 20C, and 20K (hereinafter denoted as “20W to 20K”) do not contain flat pigment particles, but contain pigment particles other than the flat pigment particles (for example, an organic pigment and an inorganic pigment) and a binder resin. The pigment particle has a shape that is closer to a spherical shape than the shape of the pigment particle 110. Herein, for the convenience of description, the second special color (W), yellow (Y), magenta (M), cyan (C), and black (K) are referred to as “other colors”, and toners in the other colors are referred to as “other-color toners”.

Consequently, in the exemplary embodiment, the toner image forming sections 20W to 20K function as an example of a second image forming section that forms a second image using a second toner not containing the flat pigment particles.

In the exemplary embodiment, the following three modes are provided: a single-color mode in which toner images of the other-color toners are not formed on the sheet member P, but a toner image of the silver toner is formed on the sheet member P; an other-color mode in which a toner image of the silver toner is not formed on the sheet member P, but a toner image of at least one of the other-color toners is formed on the sheet member P; and a mixed-color mode in which a toner image of the silver toner and a toner image of at least one of the other-color toners are formed on the sheet member P.

The single-color mode is executed by the controller 70 by not causing the toner image forming sections 20W to 20K to operate but causing the toner image forming section 20V to operate. The other-color mode is executed by the controller 70 by not causing the toner image forming section 20V to operate but causing at least one of the toner image forming sections 20W to 20K to operate. The mixed-color mode is executed by the controller 70 by causing the toner image forming section 20V and at least one of the toner image forming sections 20W to 20K to operate.

In the mixed-color mode, a toner image of the silver toner is superposed on a toner image of the other-color toner on a portion of the sheet member P to provide a silver color tinged with the other color. In the mixed-color mode, in addition, the toner image of the silver toner is provided under the toner image of the other-color toner on the transfer belt 31 (between the toner image of the other-color toner and the transfer belt 31).

The controller 70 controls the fixing device 40 so as to reduce the quantity of heat to be applied to the toner image during fixation of the toner image to the sheet member P in the case where an image forming instruction for the single-color mode and the mixed-color mode is received compared to a case where an image forming instruction for the other-color mode is received.

Consequently, the fixing device 40 (an example of a fixing section) fixes the silver toner image to the sheet member P with a small quantity of heat compared to a case where the fixing device 40 fixes an image not containing the silver toner image but containing the toner image in the other color to the sheet member P. Specifically, the controller 70 reduces the quantity of heat to be applied to the toner image during fixation by controlling the fixing device 40 so as to reduce at least one of the fixing temperature, the fixing pressure, and the fixing time.

The controller 70 is set so as to perform the same control on the fixing device 40, for example, in the single-color mode and the mixed-color mode.

<Effect of Principal Portion>

Next, the effect of the principal portion will be described. Here, the effect achieved in the mixed-color mode will be described.

When an image forming instruction for the mixed-color mode is received, the controller 70 causes the silver toner image forming section 20V and the toner image forming sections 20W to 20K for the other colors to operate as illustrated in FIG. 6. A silver toner image is formed on the photosensitive drum 21 of the toner image forming section 20V, and toner images in the other colors are formed on the respective photosensitive drums 21 of the toner image forming sections 20W to 20K.

The silver toner image is first transferred to the circulating transfer belt 31, and thereafter the toner images in the other colors are sequentially transferred to the transfer belt 31. This causes a toner image obtained by superimposing the toner images in the respective colors to be formed on the transfer belt 31. The toner image is transferred from the transfer belt 31 to the sheet member P at the transfer nip NT.

The sheet member P to which the toner image has been transferred is transported by the intermediate transport section 58 from the transfer nip NT of the transfer device 30 to the fixing nip NF of the fixing device 40. The fixing device 40 applies heat and a pressure to the sheet member P passing through the fixing nip NF. This causes the toner image transferred to the sheet member P to be fixed to the sheet member P.

In the exemplary embodiment, the silver toner image is fixed with a quantity of heat that is smaller than the quantity of heat determined under fixing conditions for the other-color mode. Consequently, the silver toner (principally, the binder resin 111) is not softened very much compared to a case where the silver toner image is fixed with the quantity of heat determined under the fixing conditions for the other-color mode, which keeps the silver toner unlikely to flow.

In contrast, in a comparative example in which the silver toner image is fixed with a quantity of heat that is larger than that in the other-color mode, for example, the silver toner (principally, the binder resin 111) is softened more than the other-color toners (principally, the binder resin), which makes it easier for the silver toner to flow. This facilitates movement of the pigment particles 110 forming the silver toner. Then, the toner image is pressurized toward the fixing belt 411 by the pressurizing roller 42. Thus, as illustrated in FIG. 1B, the pigment particles 110 are arranged in the direction along the sheet surface of the sheet member P (in the Y direction in the drawing). That is, the pigment particles 110 are arranged in a regular posture.

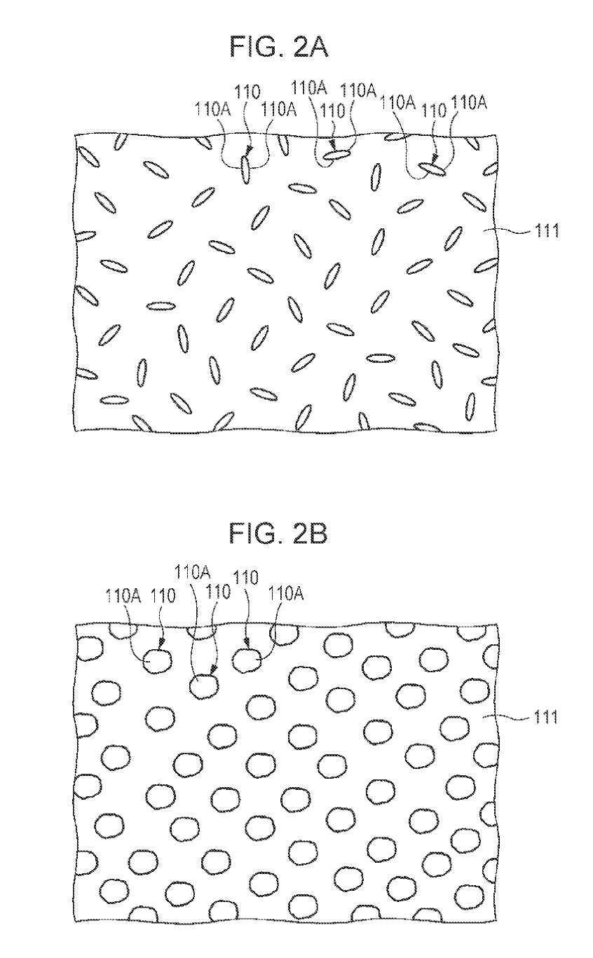

In the configuration according to the exemplary embodiment, on the other hand, the pigment particles 110 are unlikely to move even if the toner image is pressurized toward the transfer belt 411 by the pressurizing roller 42, and the posture of the pigment particles 110 is maintained in an irregular state (a random state) in a fixed image fixed to the sheet member P as illustrated in FIGS. 1A and 2A. That is, a fixed image in which the posture of flat pigment particles is irregular is obtained. Consequently, the reflective surfaces 110A of the pigment particles 110 face in irregular directions, and the image reflects light in irregular directions.

Hence, the amount of irregularly reflected light is increased compared to a case where the reflective surfaces 110A of the pigment particles 110 face in a constant direction (see FIGS. 1B and 2B), which improves the brilliance (glitter). The brilliance may be objectively evaluated using a BYK-mac (a multi-angle colorimeter manufactured by Toyo Seiki Seisaku-sho, Ltd.), for example. The term “brilliance” refers to the nature of appearing like a silver toner sparkling.

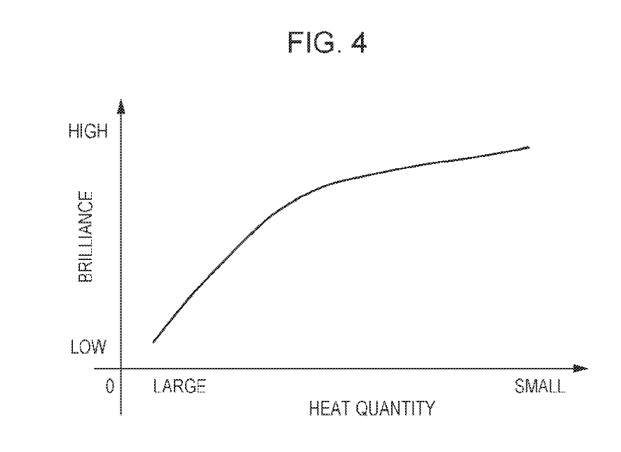

As illustrated in the graph of FIG. 4, the brilliance is improved as the quantity of heat during fixation becomes smaller.

If a small quantity of heat is used to fix an image formed with a silver toner compared to an image formed with only toners in other colors, the image formed with the silver toner and the image formed with only the toners in the other colors may appear different after being fixed, which makes the image formed with the silver toner more remarkable.

### Second Exemplary Embodiment

Next, an image forming apparatus according to a second exemplary embodiment of the present invention will be described. Portions of the present exemplary embodiment that are the same as the corresponding portions of the first exemplary embodiment are given the same reference numerals to omit description thereof as appropriate.

<Configuration>

The storage elastic modulus G′ of the other-color toners used by the toner image forming sections 20W to 20K at the fixing temperature during fixation of the toner image to the sheet member P is lower than the storage elastic modulus G′ of the silver toner at the fixing temperature.

The term “storage elastic modulus G′” indicates the real part of a complex shear elastic modulus G* at a measurement temperature T [° C.]. Specifically, the storage elastic modulus G′ of a toner is a value measured by a viscoelasticity measurement device in accordance with a method prescribed in JIS K 7244-6 “Plastics—Determination of dynamicmechanical properties—Part 6: Shear vibration—Non-resonance method”.

The storage elastic modulus G′ of a toner is adjusted in accordance with the storage elastic modulus G′ of the binder resin itself contained in the toner, for example. That is, for example, using for the other-color toners a binder resin with a storage elastic modulus G′ that is lower than the storage elastic modulus G′ of the binder resin 111 in the silver toner makes the storage elastic modulus G′ of the other-color toners lower than the storage elastic modulus G′ of the silver toner.

The storage elastic modulus G′ of a toner may also be adjusted by varying the ratio of the binder resin and the pigment particles contained in the toner, for example. In the second exemplary embodiment, the fixing temperature serving as the reference of the storage elastic modulus G′ of the silver toner and the storage elastic modulus G′ of the other-color toners is the fixing temperature in the other-color mode. Even if the fixing temperature in the single-color mode or the mixed-color mode is used as the reference temperature, the magnitude relationship between the storage elastic modulus G′ of the other-color toners and the storage elastic modulus G′ of the silver toner is not changed.

<Effect>

Next, the effect will be described.

In the exemplary embodiment, the storage elastic modulus G′ of the other-color toners at the fixing temperature is set to be lower than the storage elastic modulus G′ of the silver toner at the fixing temperature. This causes the other-color toners (principally, the binder resin) to be softened at the fixing temperature more than the silver toner (principally, the binder resin 111), which makes it easier for the other-color toners to flow.

Consequently, even if the toner images in the other colors are fixed together with the silver toner image by the fixing device 40 in the mixed-color mode with a quantity of heat that is smaller than that in the other-color mode, the effect on the image quality (such as a luster and color reproducibility) of the toner images in the other colors due to the smaller quantity of heat is suppressed.

### Third Exemplary Embodiment

Next, an image forming apparatus according to a third exemplary embodiment of the present invention will be described. Portions of the present exemplary embodiment that are the same as the corresponding portions of the first exemplary embodiment are given the same reference numerals to omit description thereof as appropriate.

<Configuration>

In the case where an image forming instruction for the mixed-color mode is received, the controller 70 controls the toner image forming sections 20W to 20K for the other colors so as to reduce the toner mass per area (TMA) in the toner images in the other colors compared to a case where an image forming instruction for the other-color mode is received. Consequently, in the mixed-color mode, the toner image forming sections 20W to 20K for the other colors form the toner images in the other colors on the sheet member P with the mass of the toner per unit area forming the toner images in the other colors reduced compared to that in the other-color mode.

The TMA indicates the mass per unit area [g/m²] of the toner in the toner image transferred to the sheet member P. The TMA is obtained by measuring the mass of a toner collected from a patch of a predetermined size through suctioning before the toner image is fixed to the sheet member P.

The TMA is controlled by adjusting the amount of toner supplied to the photosensitive drum 21 by controlling the developing bias in the developing device or the amount of the exposure light L from the exposure device 23.

<Effect>

Next, the effect will be described.

In the exemplary embodiment, in the mixed-color mode, the toner image forming sections 20W to 20K for the other colors form the toner images in the other colors on the sheet member P with the mass of the toner per unit area forming the toner images in the other colors reduced compared to that in the other-color mode.

Consequently, variations in quantity of heat per mass are suppressed even if the toner images in the other colors are fixed together with the silver toner image by the fixing device 40 in the mixed-color mode with a quantity of heat that is smaller than that in the other-color mode. This suppresses the effect on the image quality (such as a luster and color reproducibility) of the toner images in the other colors due to the smaller quantity of heat.

(Modifications)

In the exemplary embodiments described above, the toner images in the respective colors are transferred to the transfer belt 31. However, the toner images in the respective colors may be directly transferred to the sheet member P, and the toner images in the respective colors may be collectively transferred to the transfer belt 31 or the sheet member P.

In the exemplary embodiments described above, the toner images in the other colors are fixed together with the silver toner image. However, fixation of the silver toner image to the sheet member P and fixation of the toner images in the other colors to the sheet member P may be performed separately.

In the embodiments described above, the silver toner is used as the toner containing the flat pigment particles. However, the present invention is not limited thereto, and a toner in a metallic color such as gold may also be used. The gold toner contains the flat pigment particles made of aluminum or the like and yellow pigment particles, for example. That is, the toner containing the flat pigment particles may contain pigment particles other than the flat pigment particles.

The exemplary embodiments described above are merely illustrative, and the present invention is not limited thereto. The present invention may be subjected to modifications, deletions, additions, and combinations without departing from the technical scope of the present invention that may be recognized by those skilled in the art from the claims, the specification, and the drawings.

What is claimed is:

1. An image forming apparatus comprising:
a first image forming section that forms a first image using a first toner containing flat pigment particles;
a second image forming section that forms a second image using a second toner not containing the flat pigment particles; and
a fixing section that fixes the first image to a recording medium with a quantity of heat that is smaller than that for a case where the fixing section fixes a third image not including the first image but including the second image.

2. The image forming apparatus according to claim 1,
wherein a storage elastic modulus of the second toner at a fixing temperature for the case where the fixing section fixes the third image is lower than a storage elastic modulus of the first toner at the fixing temperature.

3. The image forming apparatus according to claim 1,
wherein the second image forming section forms the second image with a mass of toner per unit area forming the second image reduced in a case where the fixing section fixes the second image together with the first image to the recording medium compared to a case where the fixing section fixes the third image to the recording medium.

4. The image forming apparatus according to claim 2,
wherein the second image forming section forms the second image with a mass of toner per unit area forming the second image reduced in a case where the fixing section fixes the second image together with the first image to the recording medium compared to a case where the fixing section fixes the third image to the recording medium.

5. The image forming apparatus according to claim 1,
wherein a brilliance of the first image fixed to the recording medium is lower than a brilliance of the third image fixed to the recording medium.

6. An image forming method comprising:
forming a first image using a first toner containing flat pigment particles;
forming a second image using a second toner not containing the flat pigment particles; and
fixing an image to a recording medium with a quantity of heat,
wherein a quantity of heat used in fixing an image including the first image is smaller than a quantity of heat used in fixing a third image not including the first image but including the second image.

7. The image forming method according to claim 6,
wherein a storage elastic modulus of the second toner at a fixing temperature used in fixing the third image is lower than a storage elastic modulus of the first toner at the fixing temperature.
